(19) United States
(12) Patent Application Publication
(10) Pub. No.: US 2026/0057253 A1
(43) Pub. Date: Feb. 26, 2026

(54) METHOD AND SYSTEM OF GENERATING A CONTEXT-AWARE KNOWLEDGE GRAPH MODEL FOR TRACKING COMPUTING ROOT ERROR CAUSES

(71) Applicant: JPMorgan Chase Bank, N.A., New York, NY (US)

(72) Inventors: Bharath SRINIVASA DORESWAMY, Bangalore (IN); Anurag POLA, Hyderabad (IN); Jatin JINDAL, Jagraon (IN); Rishika GNANREDDY, Hyderabad (IN); Nilakshi REKHAWAR, Parbhani (IN); Matthew FREDERICKS, Maineville, OH (US)

(73) Assignee: JPMorgan Chase Bank, N.A., New York, NY (US)

(21) Appl. No.: 18/906,822

(22) Filed: Oct. 4, 2024

(30) Foreign Application Priority Data
Aug. 20, 2024 (IN) 202411062792

(51) Int. Cl. G06N 5/02; G06F 8/41; G06F 11/07; G06F 16/901

(52) U.S. Cl. CPC G06N 5/02; G06F 8/433; G06F 11/079; G06F 16/9024

(57) ABSTRACT

A method and system for a generating a context-aware knowledge graph model that derives a root cause of computing system errors. The method includes receiving computing job operations comprising computing system errors; compiling a data dependency list for dependencies between the computing job operations; and compiling a data structure dictionary based on the data dependency list. The method further includes generating a data structure array based on the data structure dictionary with data keys and data values, and generating the context-aware knowledge graph model by parsing and iterating through the data structure array to create nodes in the context-aware knowledge graph model and link the nodes via edges based on a key value pairing between the data keys and the data values that derives the root cause of the computing system errors by tracing and correlating of the dependencies. The method further includes displaying the context-aware knowledge graph model.

### CROSS-REFERENCE TO RELATED APPLICATIONS

This application claims priority benefit from Indian application Ser. No. 202411062792, filed on Aug. 20, 2024 in the Indian Patent Office, which is hereby incorporated by reference in its entirety.

### FIELD OF THE DISCLOSURE

This technology generally relates to methods and systems of generating a context-aware knowledge graph model for tracking computing root error causes.

### BACKGROUND

In the realm of software development or testing, potentially thousands to millions of computing jobs (or jobs for short) are being performed by a wide variety of devices, e.g., computing devices, processors, servers, virtual machines, etc. Depending on the nature of these jobs, some of the jobs may operate single-handedly or in conjunction with other related jobs. At any given moment in time, these jobs may contain an error and ticket is generated regarding such respective errors. However, it may not be clear from such alerts/tickets where, i.e., which job, is the root cause of the error. Monitoring, analyzing, and tracking the root cause of these errors to the root job from which these errors are derived is of paramount importance in order to properly identify the error and address the error at its root source. If such a root job from which the root error is not identified, then it would result in needless waste of resources, such as time, money, and computing resource fixing an error that may just be related but masking the root job error and consequently, the error would still remain. Thus, it is imperative that errors and alerts/tickets are tracked back to the computing root error causes originating from the root job error to properly identify in order to properly treat the computing root error causes.

Conventional testing methodologies fall short of being able to comprehensively perform such tracking and often miss the computing root error cause for a related error, but not a root error. Therefore, it is imperative that errors and alerts/tickets are tracked back to the computing root error causes stemming from the root job error to properly identify to treat the computing root error causes. In short, there is a strong need for a comprehensive, scalable, and user-friendly root cause analysis (RCA) capable of tracking potentially thousands to millions of errors back to the root computing error causes and the root job error from which these root computing error causes emanated from.

Accordingly, there is a need for techniques for generating a context-aware knowledge graph model for tracking computing root error causes.

### SUMMARY

The present disclosure, through one or more of its various aspects, embodiments, and/or specific features or sub-components, provides, inter alia, various systems, servers, devices, methods, media, programs, and platforms for generating a context-aware knowledge graph model for tracking computing root error causes.

According to an aspect of the present disclosure, a method for generating a context-aware knowledge graph model that derives a root cause of computing system errors in computing environments is provided. The method may be implemented by at least one processor. The method may include: receiving a plurality of computing job operations including the computing system errors from a plurality of databases related to the computing environments; compiling a data dependency list for dependencies between each of the plurality of computing job operations; and compiling a data structure dictionary based on the data dependency list.

The method further includes: generating a data structure array based on the data structure dictionary with data keys representing the each of the plurality of computing job operations and data values representing the dependencies that correlate with the data keys; generating the context-aware knowledge graph model by parsing and iterating through the data structure array to create nodes in the context-aware knowledge graph model and link the nodes via edges based on a key value pairing between the data keys and the data values that derives the root cause of the computing system errors via tracing and correlating of the dependencies; and displaying, to a user via a display interface, the context-aware knowledge graph model with a network of the nodes and the edges showing the tracing and the correlating of the dependencies between the plurality of computing job operations to the root cause of the computing system errors.

The root cause of the computing system errors may include a root computing job operation with a root computing system error from which the dependencies of the plurality of computing job operations derive.

The method may further include generating a flagging algorithm by: tagging alerts associated with each of the nodes in the context-aware knowledge graph model based on a labeling of the each of the nodes as at least one from among the root cause of computing system errors and a duplicate of the plurality of computing job operations including the computing system errors; providing a respective timestamp associated with each of the tagged alerts; generating a component name for each group of a plurality of groups, wherein each group correlates with a collection of the plurality of computing job operations; calculating a delta time difference based on the timestamp between different computing job operations associated with each of the group; identifying the component name for a target group of interest to a user from the plurality of groups, wherein the target group correlates with a target collection from among the collection of the plurality of computing job operations of interest to the user; and identifying a name of a box job including a virtual machine associated with performing at least one from among the target group and a target computing job operation of interest to the user.

The method may further include prompting, via the display interface, the user to make a selection of a particular node representing a particular computing job operation being of interest to the user; receiving, from the user via the display interface, the selection; and highlighting the particular node and the network of the nodes and the edges and the dependencies associated with the particular node in the context-aware knowledge graph model for viewing by the user via the display interface.

The method may further include predicting future computing system errors via the context-aware knowledge graph model and the flagging algorithm by parsing and iterating through subsequent computing job operations derived from the plurality of computing job operations to generate the predictions of the future computing system errors.

The method may further include implementing a classification machine learning (ML) model that classifies automated alerts.

The generating the context-aware knowledge graph model may further include a feedback loop enabling the user to provide inputs to the context-aware knowledge graph model via the display interface to update the dependencies with at least one from among new dependencies and correct the dependencies.

According to another embodiment, a computing apparatus for generating a context-aware knowledge graph model that derives a root cause of computing system errors in computing environments is provided. The computing apparatus includes: a processor; a memory; a display; and a communication interface coupled to each of the processor, the memory, and the display.

The processor is configured to: receive a plurality of computing job operations including the computing system errors from a plurality of databases related to the computing environments; compile a data dependency list for dependencies between each of the plurality of computing job operations; and compile a data structure dictionary based on the data dependency list.

The processor may be further configured to: generate a data structure array based on the data structure dictionary with data keys representing the each of the plurality of computing job operations and data values representing the dependencies that correlate with the data keys; generate the context-aware knowledge graph model by parsing and iterating through the data structure array to create nodes in the context-aware knowledge graph model and link the nodes via edges based on a key value pairing between the data keys and the data values that derives the root cause of the computing system errors via tracing and correlating of the dependencies; and display, to a user via a display interface, the context-aware knowledge graph model with a network of the nodes and the edges showing the tracing and the correlating of the dependencies between the plurality of computing job operations to the root cause of the computing system errors.

The root cause of the computing system errors includes a root computing job operation with a root computing system error from which the dependencies of the plurality of computing job operations derive from.

The processor may be further configured to generate a flagging algorithm by: tagging alerts associated with each of the nodes in the context-aware knowledge graph model based on a labeling of the each of the nodes as at least one from among the root cause of computing system errors and a duplicate of the plurality of computing job operations including the computing system errors; providing a respective timestamp associated with each of the tagged alerts; generating a component name for each group of a plurality of groups, wherein each group correlates with a collection of the plurality of computing job operations; calculating a delta time difference based on the timestamp between different computing job operations associated with each of the group; identifying the component name for a target group of interest to a user from the plurality of groups, wherein the target group correlates with a target collection from among the collection of the plurality of computing job operations of interest to the user; and identifying a name of a box job including a virtual machine associated with performing at least one from among the target group and a target computing job operation of interest to the user.

The processor may be further configured to: select, by the user via the display interface, a particular node representing a particular computing job operation being of interest to the user; and highlight the particular node and the network of the nodes and the edges and the dependencies associated with the particular node in the context-aware knowledge graph model for viewing by the user via the display interface.

The processor may further configured to predict future computing system errors via the context-aware knowledge graph model and the flagging algorithm by parsing and iterating through subsequent computing job operations derived from the plurality of computing job operations to generate the predictions of the future computing system errors.

The processor may further configured to implement a classification machine learning (ML) model that classifies automated alerts.

The generate the context-aware knowledge graph model may further include a feedback loop enabling the user to provide inputs to the context-aware knowledge graph model via the display interface to update the dependencies with at least one from among new dependencies and correct the dependencies.

According to yet another embodiment, a non-transitory computer readable storage medium storing instructions for generating a context-aware knowledge graph model that derives a root cause of computing system errors in computing environments is provided. The non-transitory computer readable storage medium comprising executable code which, when executed by a processor, causes the processor to: receive a plurality of computing job operations comprising the computing system errors from a plurality of databases related to the computing environments; compile a data dependency list for dependencies between each of the plurality of computing job operations; and compile a data structure dictionary based on the data dependency list.

The processor may be further configured to: generate a data structure array based on the data structure dictionary with data keys representing the each of the plurality of computing job operations and data values representing the dependencies that correlate with the data keys; generate the context-aware knowledge graph model by parsing and iterating through the data structure array to create nodes in the context-aware knowledge graph model and link the nodes via edges based on a key value pairing between the data keys and the data values that derives the root cause of the computing system errors via tracing and correlating of the dependencies; and display, to a user via a display interface, the context-aware knowledge graph model with a network of the nodes and the edges showing the tracing and the correlating of the dependencies between the plurality of computing job operations to the root cause of the computing system errors.

The root cause of the computing system errors includes a root computing job operation with a root computing system error from which the dependencies of the plurality of computing job operations derive from.

The storage medium including the executable code which, when executed by the processor, may cause the processor to further: generate a flagging algorithm by: tagging alerts associated with each of the nodes in the context-aware knowledge graph model based on a labeling of the each of the nodes as at least one from among the root cause of computing system errors and a duplicate of the plurality of computing job operations including the computing system errors; providing a respective timestamp associated with each of the tagged alerts; generating a component name for each group of a plurality of groups, wherein each group correlates with a collection of the plurality of computing job operations; calculating a delta time difference based on the timestamp between different computing job operations associated with each of the group; identifying the component name for a target group of interest to a user from the plurality of groups, wherein the target group correlates with a target collection from among the collection of the plurality of computing job operations of interest to the user; and identifying a name of a box job including a virtual machine associated with performing at least one from among the target group and a target computing job operation of interest to the user.

The storage medium including the executable code which, when executed by the processor, may cause the processor to further: select, by the user via the display interface, a particular node representing a particular computing job operation being of interest to the user; and highlight the particular node and the network of the nodes and the edges and the dependencies associated with the particular node in the context-aware knowledge graph model for viewing by the user via the display interface.

The storage medium including the executable code which, when executed by the processor, may cause the processor to further: predict future computing system errors via the context-aware knowledge graph model and the flagging algorithm by parsing and iterating through subsequent computing job operations derived from the plurality of computing job operations to generate the predictions of the future computing system errors.

The storage medium including the executable code which, when executed by the processor, may cause the processor to further: implement a classification machine learning (ML) model that classifies automated alerts; and wherein the generate the context-aware knowledge graph model further comprises a feedback loop enabling the user to provide inputs to the context-aware knowledge graph model via the display interface to update the dependencies with at least one from among new dependencies and correct the dependencies.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for generating a context-aware knowledge graph model that derives a root cause of computing system errors in computing environments.

FIG. 4 illustrates a flowchart of a process diagram according to an embodiment for generating a context-aware knowledge graph model that derives a root cause of computing system errors in computing environments.

FIG. 5 illustrates an example embodiment of a technical design framework for generating a context-aware knowledge graph model that derives a root cause of computing system errors in computing environments.

FIG. 6 illustrates an example embodiment of job dependencies related to generating a context-aware knowledge graph model that derives a root cause of computing system errors in computing environments.

FIG. 7 illustrates an example embodiment of job dependencies, files, and file locations related to generating a context-aware knowledge graph model that derives a root cause of computing system errors in computing environments.

FIG. 8 illustrates an example high-level visualization of a context-aware knowledge graph model according to an embodiment.

FIG. 9 illustrates an example in-depth visualization of a context-aware knowledge graph model according to an embodiment.

FIG. 10 illustrates an example visualization of tracking computing root error causes in a context-aware knowledge graph model according to an embodiment.

FIG. 11 illustrates an example embodiment of a technical design framework for generating a context-aware knowledge graph model that derives a root cause of computing system errors in computing environments with a flagging algorithm according to an embodiment.

FIG. 12 illustrates an example time series flagged data visualization for tracking computing root error causes via a context-aware knowledge graph model according to an embodiment.

FIG. 13 illustrates a flowchart of a process diagram for predicting future failures via a context-aware knowledge graph model according to an embodiment.

FIG. 14 illustrates another example embodiment of job dependencies related to generating a context-aware knowledge graph model that derives a root cause of computing system errors in computing environments.

### DETAILED DESCRIPTION

In the realm of software development or testing, potentially thousands to millions of computing jobs are being performed by a wide variety of devices in a wide variety of computing environments. At any given moment in time, these jobs may contain an error and alert is generated regarding such respective errors. However, it may not be clear from such alerts where, i.e., which job, is the root cause of the error. Conventional testing methodologies fall short of being able to comprehensively perform such tracking and often miss the computing root error cause for a related error, but not a root error. Therefore, it is imperative that such errors and alerts are tracked back to the computing root error causes originating from the root job error to properly identify in order to properly treat the computing root error causes. Doing would enable benefits such as reduction in the waste of valuable resources, e.g., but not limited to, time, money, and computing resource in tracking and addressing such computing root error causes at the root job that is the source of such errors by eliminating the errors at the source. This would then enable a correct solution to propagate throughout the dependent jobs derived from the root job and consequently, eliminating such errors from the subsequent jobs and eliminate those particular types of errors in the computing system/environments.

To address this issue of root cause analysis (RCA), the present application leverages a context-aware knowledge graph model and flagging algorithm to enable an efficient, comprehensive, and thorough RCA process to track and determine the computing root error causes and the root job from which the computing root error causes originate from.

The present application addresses these limitations in the status quo by enabling a generation of a context-aware knowledge graph model that derives a root cause of computing system errors in computing environments as described below. Notably, the context-aware knowledge graph model as described in the present application enables an analysis and identification of correlations between various types of alerts/tickets such as, but not limited to: application failure alerts; monitoring script failures; time/schedule failures related to executing a task, computing job operation, and/or process job failures; failures in software platform utilized to time/schedule a task, computing job operation, and/or process; and failures in the alerts consolidation system that maps these alerts to their respective root causes and/or mark any dependent computing job operation as failures or as duplicates. Thus, a benefit of the context-aware knowledge graph model may be effectively streamlining the alerts management process.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

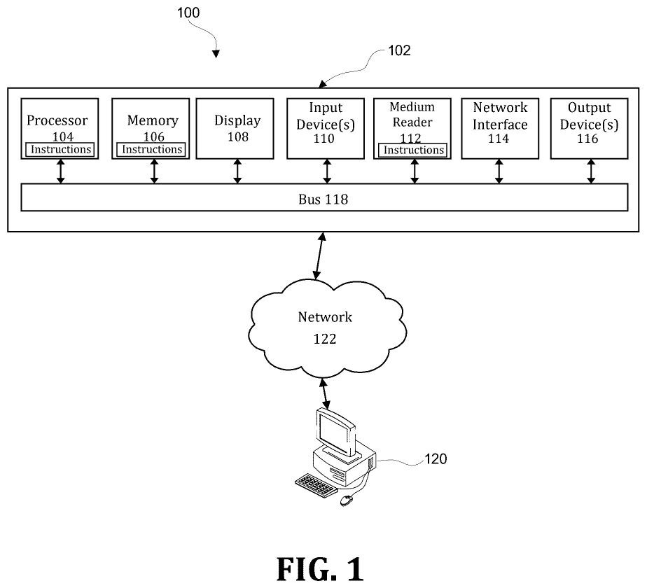

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide optimized methods and systems for generating a context-aware knowledge graph model that derives a root cause of computing system errors in computing environments.

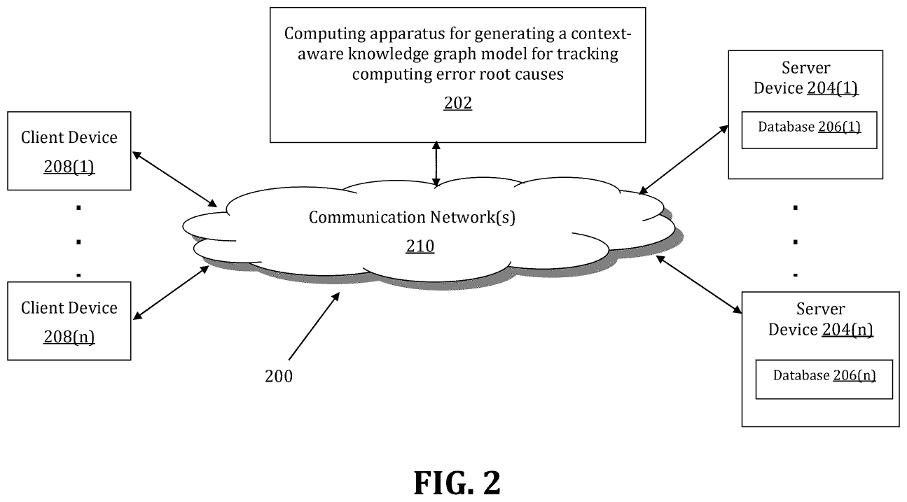

Referring to FIG. 2, FIG. 2 illustrates a network diagram of a network environment 200 for implementing a method for context-aware knowledge graph model that derives a root cause of computing system errors in computing environments may be illustrated. In an embodiment, the method may be executable on any networked computer platform, such as, for example, a personal computer (PC).

The method for a generating a context-aware knowledge graph model that derives a root cause of computing system errors in computing environments may be implemented by a computing apparatus 202 that implements a context-aware knowledge graph model that derives a root cause of computing system errors in computing environments. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method for generating a context-aware knowledge graph model that derives a root cause of computing system errors in computing environments.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

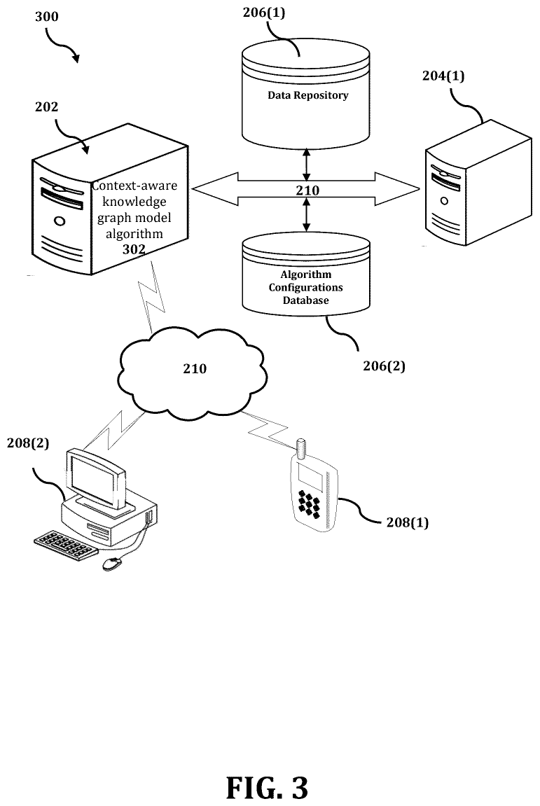

The computing apparatus 202 may be described and illustrated in FIG. 3 as including a context-aware knowledge graph model algorithm 302, although it may include other rules, algorithms, policies, modules, databases, or applications, for example. As will be described below, the context-aware knowledge graph model algorithm 302 may be configured to implement a method for generating a context-aware knowledge graph model that derives a root cause of computing system errors in computing environments.

FIG. 3 illustrates a diagram of a system environment 300 for implementing a method for generating a context-aware knowledge graph model that derives a root cause of computing system errors in computing environments by utilizing the network environment of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository 206(1) and an algorithm configurations database 206(2). The context-aware knowledge graph model algorithm 302 may be configured to access these databases for implementing the context-aware knowledge graph model that derives a root cause of computing system errors in computing environments.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

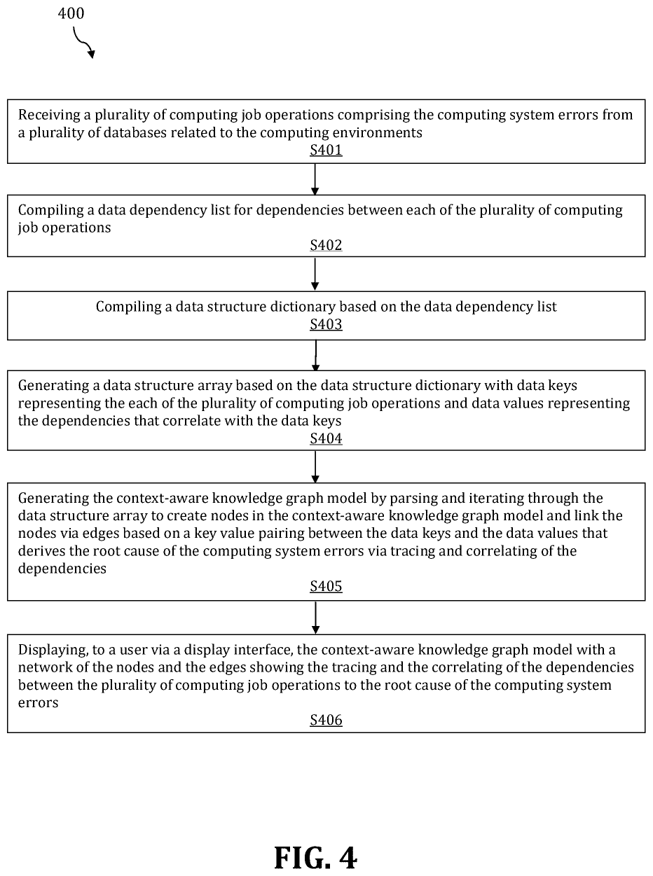

Upon being started, the context-aware knowledge graph model algorithm 302 executes a process implementing a method for the generating a context-aware knowledge graph model that derives a root cause of computing system errors in computing environments. A process for generating a context-aware knowledge graph model that derives a root cause of computing system errors in computing environments may be generally indicated at flowchart 400 in FIG. 4.

FIG. 4 illustrates a flowchart of a process diagram 400 of a process for implementing a method for generating a context-aware knowledge graph model that derives a root cause of computing system errors in computing environments according to an embodiment.

At step S401 of the flowchart process 400, the computing apparatus 202 executing the context-aware knowledge graph model algorithm 302 may receive a plurality of computing job operations comprising the computing system errors from a plurality of databases related to the computing environments. The computing job operations (or jobs for short) may be, but not limited to, program operations/functions, financial transactions, software testing/development, etc. The computing job operations may be performed by a wide variety of devices such as, but not limited to, computing devices, processors, servers, virtual machines, etc. The databases may be, but not limited to, current and prior data operations data logs/databases, data management systems, etc. In an example, the computing job operations may be set of processes or operations that a computing system may execute on a pre-defined time. For instance, the pre-defined time may be set to a particular date, time, month, year, etc. as so desired. In an example, the computing job operations may be executed using stored process instructions, e.g., a database process with defined steps for executing the computing job operations at a pre-defined time.

At step S402, the computing apparatus 202 executing the context-aware knowledge graph model algorithm 302 may compile a data dependency list for dependencies between each of the plurality of computing job operations. In an example, the data dependency list may provide a list showing the various computing job operations and other job operations that depends from each of the various computing job operations. For instance, the dependency list may be created via a spreadsheet with various columns. In an example, the first column may list the computing job operations, the second column may list commands associated with the respective computing job operations (i.e., job commands) such that if row 1 has a particular computing job operation, then all of the commands associated with that particular computing job operation jobs may be in column 2 at row 2. This would continue until a computing job operation occurs. Still with that example, the third column may list dependent command jobs associated with the respective computing job operations. For instance, if a row has a command job, then all of its dependent jobs may be in column 3 at the relevant next row. If more than one computing job operation exists, then they may be separated by an ampersand (&) or pipe/vertical bar (|). Alternatively, if there are no dependent computing job operations, then column 3 would be empty.

At step S403, the computing apparatus 202 executing the context-aware knowledge graph model algorithm 302 may compile a data structure dictionary based on the data dependency list.

At step S404, the computing apparatus 202 executing the context-aware knowledge graph model algorithm 302 may generate a data structure array based on the data structure dictionary with data keys representing the each of the plurality of computing job operations and data values representing the dependencies that correlate with the data keys.

At step S405, the computing apparatus 202 executing the context-aware knowledge graph model algorithm 302 may generate the context-aware knowledge graph model by parsing and iterating through the data structure array to create nodes in the context-aware knowledge graph model and link the nodes via edges based on a key value pairing between the data keys and the data values that derives the root cause of the computing system errors via tracing and correlating of the dependencies. In an example, the root cause of the computing system errors comprises a root computing job operation with a root computing system error from which the dependencies of the plurality of computing job operations derive.

The context-aware knowledge graph model may be a context-aware directed labeled graph in which the labels have pre-defined meanings. The context-aware directed labeled graph may include nodes, edges linking the nodes, and labels. In an example, the node may represent a computing job operation. An edge links a pair of nodes together and thus, visually captures a relationship of interest between them. For instance, an edge that links two nodes in the present application visually captures a dependency relationship between the two nodes. For example, in the present application, the label may have a pre-defining meaning associated with a name of a computing job operation. The directed labeled may be formally described via an equation: for given a set of nodes N and a set of labels L, then the context-aware knowledge graph may be a subset of the cross product of N×L×N. Each member of this set may be referred to as a triple with a first node A connected via edge B to a second node B.

The linking of the nodes via edges may result in various paths in the he context-aware knowledge graph model such as, but not limited to, a path, simple path, and/or cycle. For instance, a path in the context-aware knowledge graph model may occur for a series of nodes (v₁, v₂, . . . , vₙ) where for any edge i ε N with 1≤i<n, there may exist an edge from vi to vi+1, i.e., from one node to another node. A simple path may be a path with no repeated nodes, while a cycle may be a path in which the first and the last nodes may be the same node. In the present application, since dependencies between computing job operations are of interest, the focus may generally be on those paths in which the edge linking the nodes depict a dependency relationship between for the various pairs of nodes. Traversal through the nodes and edges, i.e., path traversals, of the context-aware knowledge graph model may be performed using various techniques such as, but not limited to, shortest path, Hamiltonian path, etc.

Continuing with step S405, the computing apparatus 202 executing the context-aware knowledge graph model algorithm 302 may generate the context-aware knowledge graph model by including a feedback loop enabling the user to provide inputs to the context-aware knowledge graph model via a display interface to update the dependencies with at least one from among new dependencies and correct the dependencies.

At step S406, the computing apparatus 202 executing the context-aware knowledge graph model algorithm 302 may display, to a user via a display interface, the context-aware knowledge graph model with a network of the nodes and the edges showing the tracing and the correlating of the dependencies between the plurality of computing job operations to the root cause of the computing system errors.

Continuing with step S406, the computing apparatus 202 executing the context-aware knowledge graph model algorithm 302 may further prompt, via the display interface, the user to make a selection of a particular node representing a particular computing job operation being of interest to the user; receive, from the user via the display interface, the selection; and highlight the particular node and the network of the nodes and the edges and the dependencies associated with the particular node in the context-aware knowledge graph model for viewing by the user via the display interface.

In yet another embodiment, the computing apparatus 202 executing the context-aware knowledge graph model algorithm 302 may implement a classification machine learning (ML) model that classifies automated alerts. In an example, the classification ML model may include, but not limited to, logistic regression, naïve bayes, k-nearest neighbors, decision trees, support vector machines, random forest, etc.

In yet another embodiment, the computing apparatus 202 may generate a flagging algorithm, which operates in conjunction with the context-aware knowledge graph model algorithm 302, by: tagging alerts associated with each of the nodes in the context-aware knowledge graph model based on a labeling of the each of the nodes as at least one from among the root cause of computing system errors and a duplicate of the plurality of computing job operations comprising the computing system errors; providing a respective timestamp associated with each of the tagged alerts; generating a component name for each group of a plurality of groups, wherein each group correlates with a collection of the plurality of computing job operations; calculating a delta time difference based on the timestamp between different computing job operations associated with each of the group; identifying the component name for a target group of interest to a user from the plurality of groups, wherein the target group correlates with a target collection from among the collection of the plurality of computing job operations of interest to the user; and identifying a name of a box job comprising a virtual machine associated with performing at least one from among the target group and a target computing job operation of interest to the user.

Additionally, in an embodiment, the computing apparatus 202 executing the context-aware knowledge graph model algorithm 302 may further predict future computing system errors via the knowledge graph and the flagging algorithm by parsing and iterating through subsequent computing job operations derived from the plurality of computing job operations to generate the predictions of the future computing system errors.

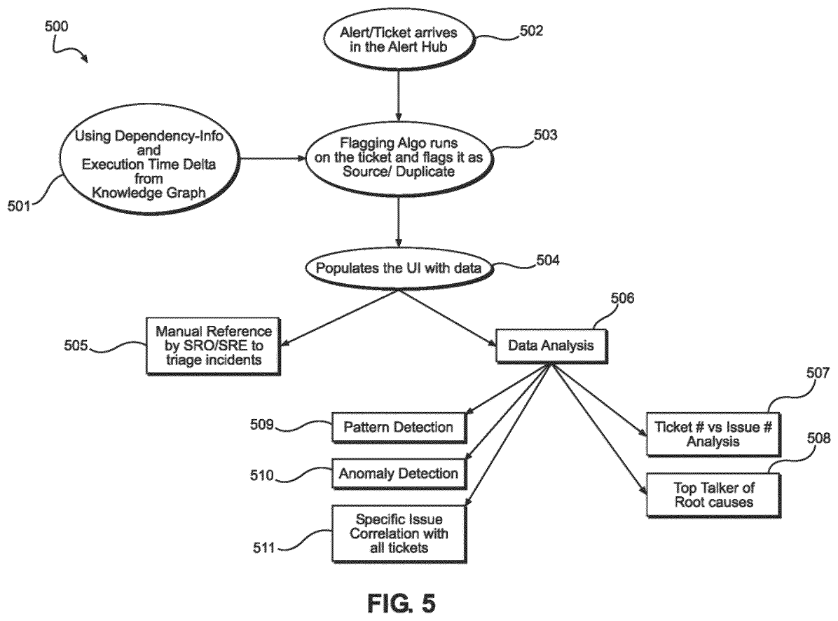

FIG. 5 illustrates an example embodiment of a technical design framework 500 for generating a context-aware knowledge graph model that derives a root cause of computing system errors in computing environments according to an embodiment. At process 501, dependency information is utilized to executing a delta time calculation using the context-aware knowledge graph model. In an example, calculating a delta time difference may be based on the timestamp between different computing job operations associated with each of the group.

At process 502, an alert/ticket arrives from the ticket hub, such as, e.g., a data management system with an alerts consolidation system for managing and generating alerts/tickets. An alert may denote a notification message when a planned event occurs, as well upon a ticket or incident occurring. The alert may be managed or generated via an alerts consolidation system. A ticket may denote an incident in a service queue and may include an incident identification number. An incident may denote any change or addition to an existing computing system under monitoring or observation, wherein the incident may be associated with an error. The alert/ticket may be transmitted to the flagging algorithm, whose process is described at process 503. At process 503, the flagging algorithm may be run on the alert/ticket and may flag such alert/ticket as a source (e.g., root cause of the computing system errors) or as a duplicate dependency or duplicate computing job operation or as a symptom/duplicate of the root cause. That is, the flagging algorithm enables labeling computing job operation into various groupings of computing job operation based on, e.g., root cause or as a duplicate dependency or duplicate computing job operation or symptoms. Note that at process 503, the flagging algorithm receives data from both the processes at 501 and 502.

Continuing with FIG. 5, the process at 503 transmits flagging data to the process 504, wherein the flagging data may be used to populate the user interface (UI) with resulting data (e.g., the flagging data from process 503). The populated UI from 504 may then transmit the resulting data for manual reference by a site reliability operator (SRO) or a site reliability engineer (SRE) 505 as part of a technology team to triage the alerts/tickets based on e.g., an incident severity, severity of threat to the computing system/environment, severity of the error, etc. The severity may be based on a threshold metric wherein being at or above the threshold metric may denote a severity. The threshold metric may be selected by the SRO/SRE or a user of the method for generating a context-aware knowledge graph model that derives a root cause of computing system errors in computing environments and may of any value as desired by the SRO/SRE or user. For instance, the threshold metric may be at or above 80%, 85%, 90%, 95%, etc., although it may be any other desired value.

Continuing with FIG. 5, the populated UI from 504 may also transmit the resulting data for data analysis 506. The data analysis 506 may include, but not limited, pattern detection 509, anomaly detection 510, specific issue correlation with all tickets/alerts 511, an analysis of alert/ticket number vs. issue number 507, and/or a top talker of root causes 508 (i.e., top reason for the root cause of computing system errors). An issue may denote an actual problem, e.g., an actual error.

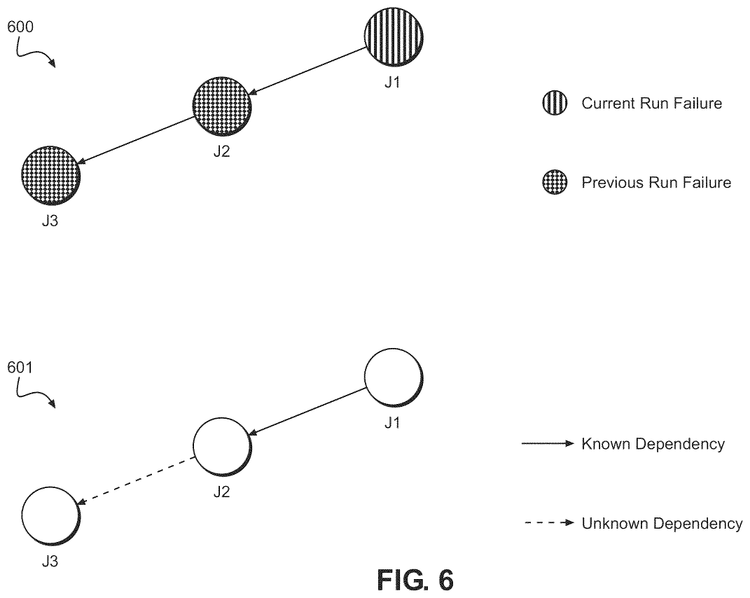

FIG. 6 illustrates an example embodiment of job dependencies 600 related to generating a context-aware knowledge graph model that derives a root cause of computing system errors in computing environments. At 600, an example shows a current and previous run failures of the computing job operations and the relationships between the different computing job operations. For instance, J1 denotes a current failure, while J2 and J3 denotes a previous run failure. At 601, an example shows the dependencies associated with the computing job operations. As may be seen at 601, it may already be known that J1 and J2 share a dependency, but it may not have been known that J2 and J3 share a dependency. Thus, it would not have been known that J1 would have a dependency with J3 because this dependency was not previously known. The present application leverages the context-aware knowledge graph model with a delta time difference calculation to map and track such dependencies that may not be readily apparent. The use of the flagging algorithm also helps to highlight these potential unknown dependencies.

So, for instance, the SRE/SRO or user may know what the current runs/operations are and are not, but the SRE/SRO or user may not be fully aware of the dependencies associated with such runs/operations because thousands of millions to such runs/operations may be occurring throughout different computing systems in various computing environments. However, the context-aware knowledge graph model would be able to map and track such dependencies and provide the result data to the SRE/SRO or user such that the SRE/SRO would be able to make an informed decision regarding what actions, if any, to take. That is, based on the dependencies that failed or passed in current run, a more informed decision can be made.

Additionally, the resulting data may also be utilized to predict what other computing job operations, if any, might fail in the future by evaluating the current failures in current runs/operations in correlation with the previous runs/operations. In an example, anomaly detection may be performed on JI and J3. For example, let J1 and J3 denote failures in a certain run/operation, then these failures at J1 and J3 may represent an anomaly in the run/operation. As such, an anomaly has been detected by the evaluation.

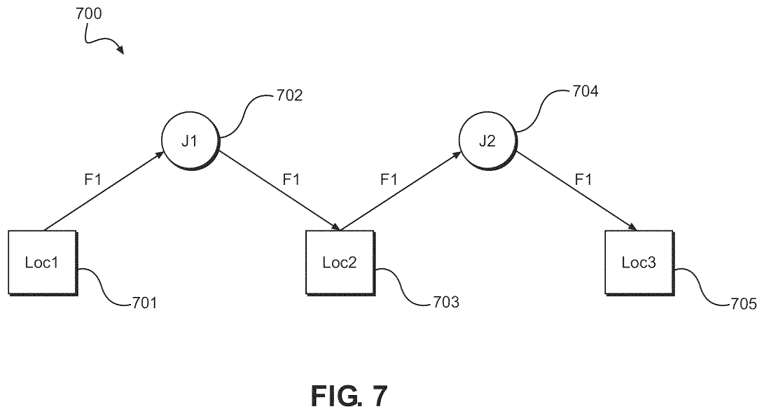

FIG. 7 illustrates an example embodiment of job dependencies, files, and file locations 700 related to generating a context-aware knowledge graph model that derives a root cause of computing system errors in computing environments. In an example, J1 702 denotes a first computing job operation and J2 704 denotes a second computing job operation, wherein the computing job operations of J1 702 and J2 704 may be transfer a specific file F1 from one location to another, e.g. a first location Loc1 701, a second location Loc2 703, and a third location Loc3 705. That is, J1 702 transfers F1 from Loc1 701 to Loc2 703 and J2 704 transfers F1 from Loc2 703 to Loc3 705.

Continuing with FIG. 7, it may be seen that J2 704 may be dependent on J1 702. Thus, if J1 702 fails, then J2 704 may also fail as well. In this case, two alerts may be generated, but the actual issue lies with J1 702, i.e., it is the source/root cause of the computing system errors. Note that the alerts may be generated because there may not be any context between the failures, and consequently alerts, associated with the computing job operations. For instance, the alerts may state an error message such as “File does not exist at Loc1 701 or Loc2 703”, which does not provide the SRE/SRO or user with any knowledge regarding these alerts and error. The notable point being that these alerts may be just duplicate alerts relating to the same issue and error. As such, the present application provides the necessary context via the context-aware knowledge graph model.

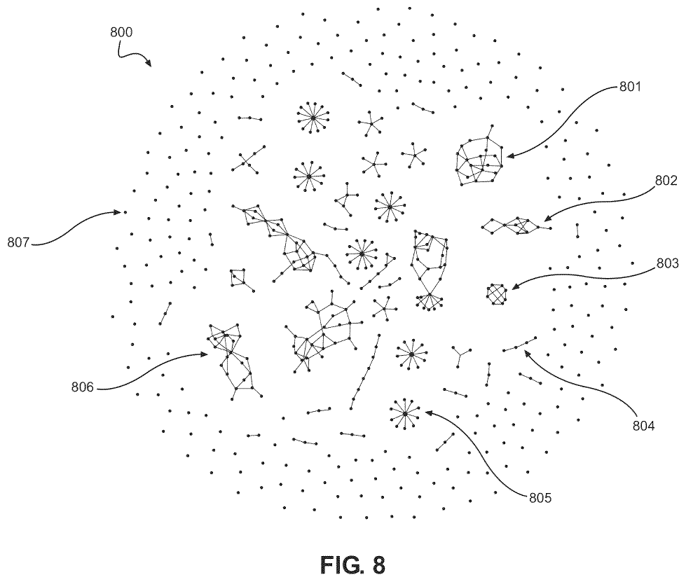

FIG. 8 illustrates an example high-level visualization of a context-aware knowledge graph model 800 according to an embodiment. The high-level visualization of a context-aware knowledge graph model 800 depicts different groups of a plurality of groups 801-807, wherein each group as represented by each group of 801-807 correlates with a collection of the plurality of computing job operations denoted by the nodes linked with the edges (e.g., lines). The edges depicting the dependencies between the different computing job operations. The different groups of a plurality of groups 801-807 have different shapes due to the differing dependencies associated with the different computing job operation(s). For instance, 801-803, 805, and 806 depict different shapes that may resemble geometrical shapes or configurations due to their various differing dependencies. The group 807 shows a straight line based on the differing dependencies within this particular group. The singular group 807 shows a lone node because no dependencies exist with that particular computing job operation and thus, may be represented as a singular node. That is, the particular shape or configuration varies in correlation with each group and/or a particular computing job operation within each group or in the singular group and any dependencies, if any, that originate from the particular computing job operation, wherein the context-aware knowledge graph model algorithm 302 may generate this shape or configuration for the context-aware knowledge graph model. Hence, the context-aware aspect context-aware knowledge graph model that enables analysis and tracking of the various dependencies such that the tracing and the correlating of the dependencies between the plurality of computing job operations to determine the root cause of the computing system errors. The visualization may be viewed via a display interface.

Additionally, a flagging algorithm may operate in conjunction with the context-aware knowledge graph model to provide additional flagging processes and information related to the particular computing job operation and/or each group. The explanations above also similarly apply to the other various groups or singular groups as depicted in FIG. 8. Note that the example high-level visualization of the context-aware knowledge graph model 800 is provided as an example and is not to be construed as limiting the context-aware knowledge graph model to this particular visualization.

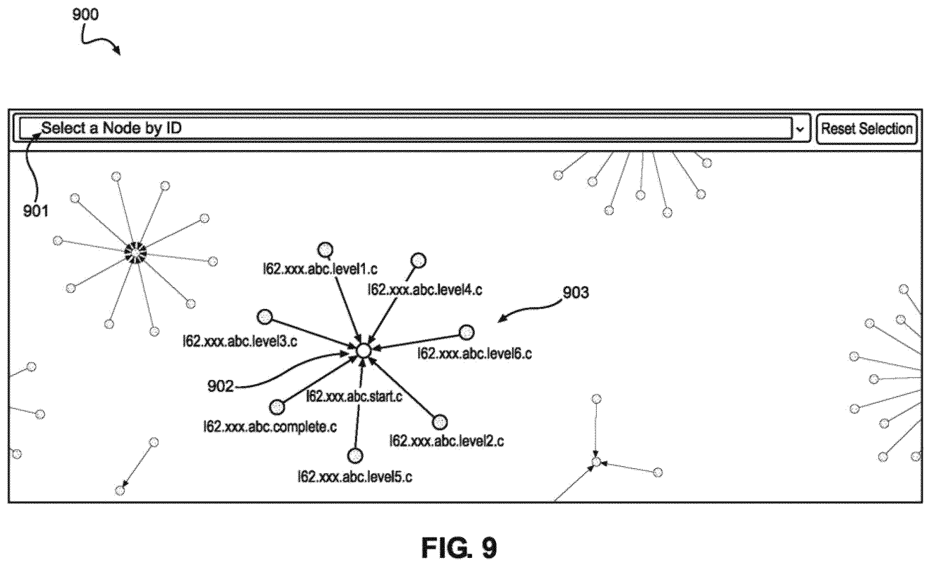

FIG. 9 illustrates an example in-depth visualization of a context-aware knowledge graph model 900 according to an embodiment. A node selection may be made at the node selection search bar 901, wherein a user or SRO/SRE may select an in-depth visualization of a particular node by inputting its node identifier into the node selection search bar 901. Additionally, the user or SRO/SRE may reset the node selection search bar 901 to select another node of interest. Once a node identifier has been selected, then the particular node and its various dependencies may be visualized in-depth. In an example, the central node 902 as identified by a node identifier with various letters and numbering at 902 represents the particular computing job operation that may have been selected, wherein the user or SRO/SRE may input this node identifier into the node selection search bar 901 to depict the in-depth visualization via the context-aware knowledge graph model for this node and its dependencies. The dependencies may be depicted as linked edges emanating from the central node 902. For instance, a dependent node 903 as identified by the node identifier at 903 may emanate from the central node 902 since it may share a dependency with the central node 902. Similarly, for the other dependent nodes that may emanate from the central node 902.

Note that in this visualization at FIG. 9, the visualization possesses this particular shape because the dependencies to the central node 902 may be optimally visualized in this configuration. The visualization may be viewed via a display interface. Note also that the example in-depth visualization of a context-aware knowledge graph model 900 is provided as an example and is not to be construed as limiting the context-aware knowledge graph model to this particular visualization.

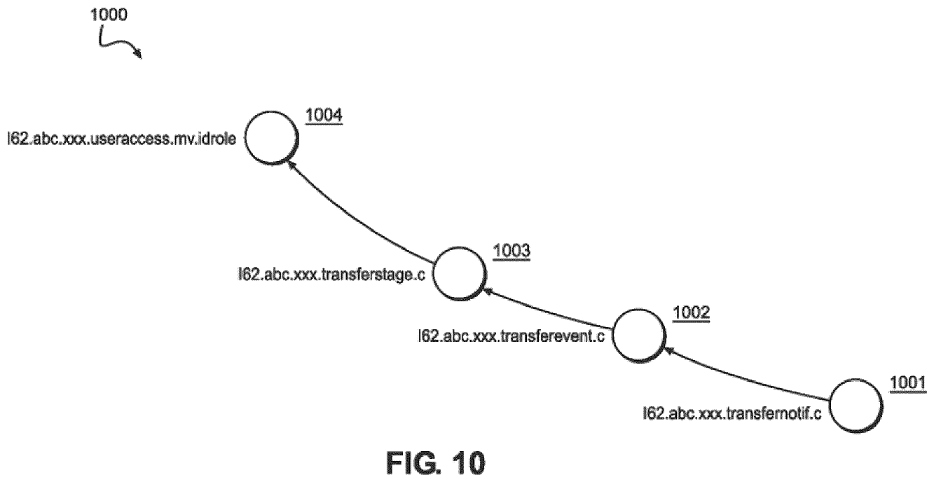

FIG. 10 illustrates an example visualization of tracking computing root error causes in a context-aware knowledge graph model 1000 according to an embodiment. Various nodes are depicted at 1001-1004. The visualizations of the context-aware knowledge graph model enable a tracking of a node representing a computing job operation of interest to the user or SRO/SRE at the granular level. That is, the context-aware knowledge graph model enables traceback capability and examination of the execution flow of computing job operations. For instance, if the user or SRO/SRE selects node 1001 as identified with node identifier 162.abc.xxx.transfernotif.c, then a flow execution shows the related computing job operations as denoted at 1002-1004. The execution flow of computing job operations may show the connected computing job operations within a pre-defined execution time period.

Additionally, the context-aware knowledge graph model may operate in conjunction with the flagging algorithm to flag certain job operations. For instance, the node 1003 may be flagged as denoted by the bolded highlight or the node 1004 and/or node 1002 may be flagged as denoted by the boxes. The reasons for the flagging may vary, e.g., the node may of the interest to the user or SRO/SRE, the node may be associated with an error severity, etc. That is, the reasons for the flagging may be flexible and may be varied accordingly as desired or needed.

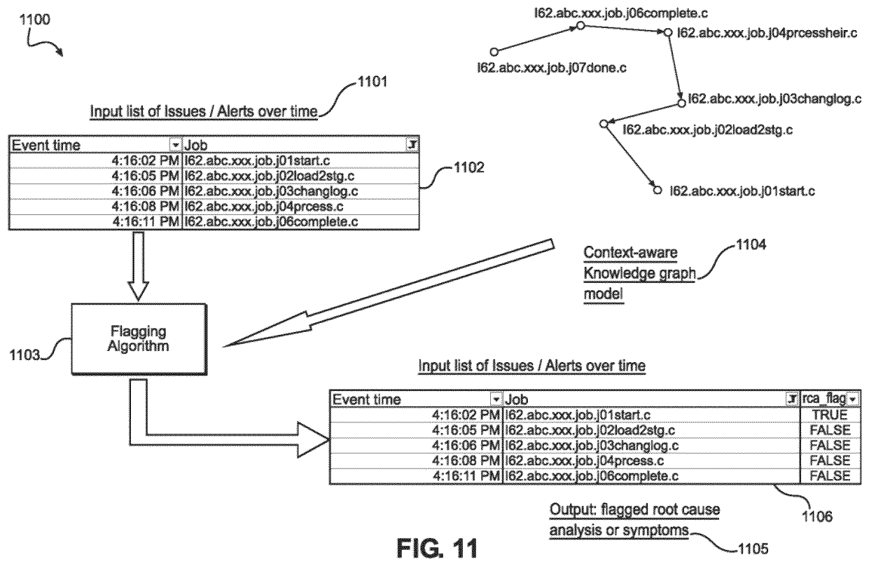

FIG. 11 illustrates an example embodiment of a technical design framework 1100 for generating a context-aware knowledge graph model that derives a root cause of computing system errors in computing environments with a flagging algorithm according to an embodiment. The technical design framework 1100 illustrates an input list of issues or alerts overtime 1101 may be compiled. The input list of issues or alerts over time 1101 may be represented in a spreadsheet 1102 compiling the various events and computing job operations. A delta time may be computed and tabulated at spreadsheet 1102 by segregating and compiling the job failures that occur at a particular time bracket. For example, the time bracket as tabulated at the spreadsheet 1102 may be at 4:16 PM, wherein the job failures that occur within this time bracket are segregated and cataloged for analysis. Continuing with the example, it may be seen that from 4:16:02 PM to 4:16:11 PM, there may be six job failures. The various jobs may be depicted at the various nodes in the context-aware knowledge graph model 1104, which is further described below.

The spreadsheet 1102 may be transmitted to a flagging algorithm 1103. The flagging algorithm may also receive data derived from the context-aware knowledge graph model 1104. Note the nodes and linked edges that connect the various computing job operations represented at each of the individual nodes and the node identifiers associated with each node that identifies the node with the particular computing job operation in the context-aware knowledge graph model 1104. For example, the nodes may show various jobs that may include a first job (with an identifier that may include the label j01 to denote the first job) to a seventh job (with an identifier that may include the label j07 to denote a seventh job), etc.

The flagging algorithm 1103 may utilize the data obtained from the spreadsheet 1102 and the context-aware knowledge graph model 1104 to generate resulting flagged outputs 1105 such as, but not limited to, root cause analysis (RCA) or symptoms/duplicates. That is, the resulting flagged outputs 1105 may provide an indication that the issue/alert associated with a particular computing job operation may be a root cause of computing system errors in computing environments or may merely be a symptom/duplicate and that some other computing job operation associated with some other issue/alert would be the root cause. The resulting flagged outputs 1105 may summarized in a resulting flagged outputs spreadsheet 1106, wherein true may denote a root cause, while false may denote a symptom/duplicate. Note that the values and computing job operations shown in this technical design framework 1100 are provided as examples and are not to be construed as limiting the context-aware knowledge graph model and flagging operation to these particular values and computing job operations.

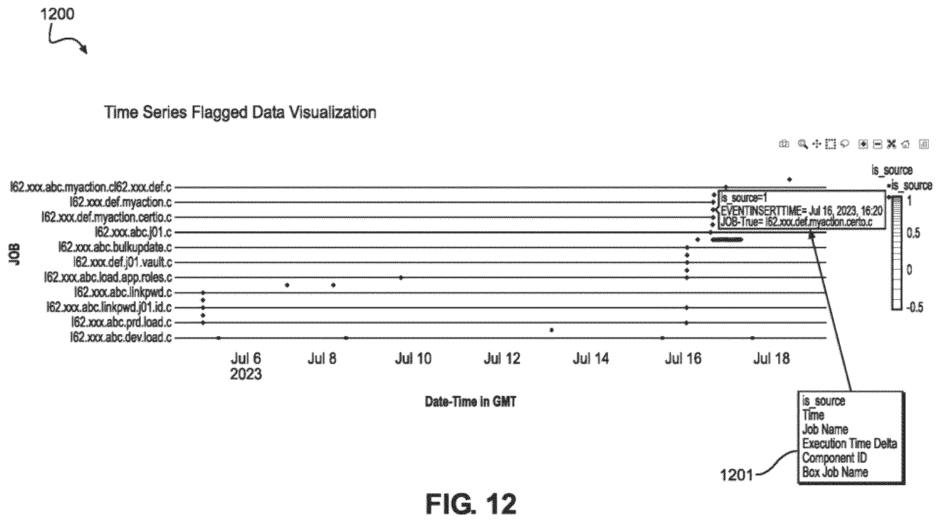

FIG. 12 illustrates an example time series flagged data visualization 1200 for tracking computing root error causes via a context-aware knowledge graph model according to an embodiment. The time series flagged data visualization 1200 may show a plot of computing job operations vs. date-time within a particular time zone (e.g., Greenwich Mean Time as shown in this example). For instance, if a user or SRO/SRE hovers over a dot in the time series flagged data visualization 1200 plot, then details regarding the dot may show attribute information as stated in the legend 1201. That is, a hovering over the dot may provide the user or SRO/SRE with attribute information such as, but not limited to: is_source (may indicate whether the computing job operation may be a root cause or a symptom/duplicate); time (may indicate a timestamp associated with the alert/issue); job (may indicate a name of the computing job operation); delta time (may indicate executing delta time between different computing job operations); component_ID (may indicate an identification associated with the computing job operation(s)); box job name (may indicate name associated with a box computing job operation)). The box job name may include an indication of a virtual machine associated with performing computing operations of a target group of computing operations of interest to the user or SRO/SRE, and/or a target computing job operation of interest to the user or SRO/SRE.

Additionally, computing job operations with the same component ID may be so indicated with the same color in the time series flagged data visualization 1200. The attribute information provided in the legend 1201 may help the user or SRO/SRE may help debugging procedures to be performed more efficiently and faster with less drain on computing resources because the root cause may be more easily tracked, identified, and viewed. The time series flagged data visualization 1200 may be viewed via the display interface and a selection of a particular dot would show only alerts associated with the particular dot that are part of the component representing the particular computing job operation(s).

Note that the data and visualization as shown in the time series flagged data visualization 1200 are provided as examples and are not to be construed as limiting the time series flagged data visualization to these particular data and visualization.

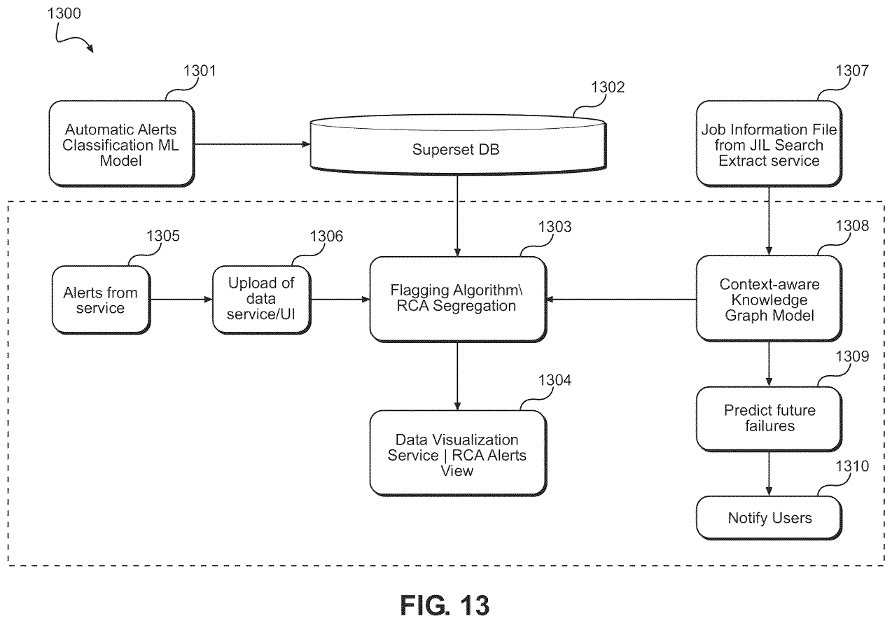

FIG. 13 illustrates a flowchart of a process diagram 1300 for predicting future failures via a context-aware knowledge graph model according to an embodiment. The process diagram 1300 may include a process wherein alerts may automatically be classified 1301 using a classification machine learning (ML) model that may be transmitted for saving in a superset database (DB) 1302. In an example, the classification ML model may include, but not limited to, logistic regression, naïve bayes, k-nearest neighbors, decision trees, support vector machines, random forest, etc. The data from the superset DB 1302 may be pulled by the flagging algorithm 1303 as part of the root cause analysis (RCA) to segregate the root cause from the symptom/duplicate.

Continuing with FIG. 13, alerts may be obtained from a service such as an alerts consolidation system 1305. The alerts at 1305 may then be pulled via an upload data service or user interface (UI) 1306. These pulled alerts at 1306 may be modified by the upload data service or UI and transmitted to the flagging algorithm 1303.

Continuing with FIG. 13, a job information file may be obtained from a job information log (JIL) search extraction service 1307. That is, at 1307, the JIL search extract service pulls data from a JIL search application programming interface (API). The job information file at 1307 may be transmitted to the context-aware knowledge graph model algorithm 302 to generate the context-aware knowledge graph model 1308 showing the nodes and linked edges depicting various dependences between the nodes representing the computing job operations. Additional data properties such as, but not limited to, dependencies between computing job operations and execution delta time may be available for transmission to the flagging algorithm 1303 for utilization by the flagging algorithm 1303.

Continuing with FIG. 13, the flagging algorithm 1303 may process the data from the superset DB 1302, the pulled alerts at 1306, and the data properties from context-aware knowledge graph model at 1308 as part of the root cause analysis (RCA) to segregate the root cause from the symptom/duplicate. The segregation data may be visualized via a data visualization service with RCA alerts view at 1304. This data visualization service may enable the segregation data to be visualized via a display interface.

Continuing with FIG. 13, the segregation data from flagging algorithm 1303 along with the context-aware knowledge graph model 1308 may be utilized to predict future failures 1309. For instance, based on the segregation data from the flagging algorithm 1303 and dependencies derived from the context-aware knowledge graph model 1308, a computing job operation may be selected and as part of the RCA process, iterations may be made through the various dependencies associated with computing job operation, e.g., child dependent computing job operations, to predict whether such child dependent computing job operations may fail in the future based on the current computing job operation and previous computing job operations including previous child computing job operations. Once such predictions of future failures 1309 may be ascertained, then notifications may be generated to notify users 1310 of which computing job operations may fail in the future so that appropriate preventive and/or remedial measures may be taken.

The context-aware knowledge graph model provides numerous benefits to a business organization, SRO/SRE, or any other type of user or organization because it enables correlation between computing job operations, alerts, and incidents to accurately and reliably identify root cause of the computing system errors via tracing and correlating of the dependencies via the context context-aware knowledge graph model. Additionally, the context-aware knowledge graph model prevents wasted redundant efforts spent on trying to examine duplicate alerts and fixing duplicate issues and thus, markedly reduces manual debugging efforts by SRO/SRE or other such personnel. Indeed, the context-aware knowledge graph model enables increased focus on resolving root cause of the computing system errors rather than some irrelevant symptom/duplicate of the root cause. Furthermore, the context-aware knowledge graph model in conjunction with the flagging algorithm help to monitor, examine, analyze, track, and predict alert trends and patterns over time, as well as enable predictive capabilities that may predict future failures based on the delta time calculations and enable prioritization of tickets or computing job operations based on these predicted failures and the potential impact of such failures.

Therefore, the context-aware knowledge graph model provides efficient and user-friendly process for tracing and correlating of the dependencies associated with computing job operations. Indeed, the context-aware knowledge graph model, as well as the flagging algorithm acting in conjunction with the context-aware knowledge graph model, may perform RCA analysis on thousands to millions of computing job operations and their related alerts and issues and efficiently, accurately, and expediently distill this large amount of data into concise and actionable data for immediate use by a user, or business organization, or SRO/SRE to identify errors, the severity of such errors, and triage/prioritize this actionable data for immediate remediation actions.

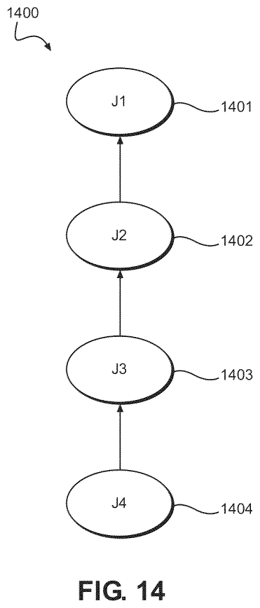

FIG. 14 illustrates another example embodiment of job dependencies 1400 related to generating a context-aware knowledge graph model that derives a root cause of computing system errors in computing environments. In an example, there may be a cluster C1 of job dependencies 1400 that includes a first job J1 1401, a second job J2 1402, a third job J3 1403, a fourth job J4 1404 that may have various dependencies. The cluster C1 may be scheduled to run at multiple time periods daily with an interval of, e.g., two hours, which may denote a delta time frame. For instance, the cluster C1 may be run at a first execution time E1 at, e.g., 2:00 PM; a second execution time E2 at e.g., 4:00 PM; and a third execution time E3 at e.g., 6:00 PM.

Continuing with FIG. 14, an example of a list of job failures may be compiled based on the execution times E1-E3 and in association with the jobs J1-J4 1401-1404 as shown in Table 1 below.

TABLE 1
Compilation of job failures.

| Job name (J#) | Time of failure | Execution time (E#) |
|---|---|---|
| J1 | 2:00 PM | E1 |
| J2 | 2:02 PM | E1 |
| J3 | 2:03 PM | E1 |
| J4 | 2:04 PM | E1 |
| . . . | . . . | . . . |
| J3 | 4:03 PM | E2 |
| . . . | . . . | . . . |
| J4 | 6:05 PM | E3 |

Continuing with FIG. 14, a delta time frame corresponding to the job failures may be determined, along with whether the particular job failure denotes a root cause of the computing system errors, a duplicate of the root cause, or a symptom of the root cause (see Table 2 below). That is, a delta time frame may be determined, wherein the delta time frame denotes a duration between two consecutive job execution schedules. By time bounding using the delta time frame for each job, errors regarding the flagging of incorrect dependent jobs in the job failure list may be eliminated.

TABLE 2
Summary of error flags with types of failures.

| Job name (J#) | Time of failure | Type of failure |
|---|---|---|
| J1 | 2:00 PM | Root Cause Failure. |
| | | Parent job with no dependent jobs. |
| J2 | 2:02 PM | Duplicate/Symptom. |
| | | Failed due to J1 dependency. |
| J3 | 2:03 PM | Duplicate/Symptom. |
| | | Failed due to J2 dependency. |
| J4 | 2:04 PM | Duplicate/Symptom. |
| | | Failed due to J3 dependency. |
| . . . | . . . | . . . |
| J3 | 4:03 PM | Root Cause Failure. |
| | | Parent job with no dependent jobs |
| | | having an execution failure in the |
| | | execution time E2. |
| . . . | . . . | . . . |
| J4 | 6:05 PM | Root Cause Failure. |
| | | Parent job with no dependent jobs |
| | | having an execution failure in the |
| | | execution time E3. |

Although the invention has been described with reference to several embodiments and an example embodiment configuration, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating a context-aware knowledge graph model that derives a root cause of computing system errors in computing environments, the method being implemented by at least one processor, the method comprising:
receiving a plurality of computing job operations comprising the computing system errors from a plurality of databases related to the computing environments;
compiling a data dependency list for dependencies between each of the plurality of computing job operations;
compiling a data structure dictionary based on the data dependency list;
generating a data structure array based on the data structure dictionary with data keys representing the each of the plurality of computing job operations and data values representing the dependencies that correlate with the data keys;
generating the context-aware knowledge graph model by parsing and iterating through the data structure array to create nodes in the context-aware knowledge graph model and link the nodes via edges based on a key value pairing between the data keys and the data values that derives the root cause of the computing system errors via tracing and correlating of the dependencies; and
displaying, to a user via a display interface, the context-aware knowledge graph model with a network of the nodes and the edges showing the tracing and the correlating of the dependencies between the plurality of computing job operations to the root cause of the computing system errors.

2. The method of claim 1, wherein the root cause of the computing system errors comprises a root computing job operation with a root computing system error from which the dependencies of the plurality of computing job operations derive.

3. The method of claim 1, further comprising generating a flagging algorithm by:
tagging alerts associated with each of the nodes in the context-aware knowledge graph model based on a labeling of the each of the nodes as at least one from among the root cause of computing system errors and a duplicate of the plurality of computing job operations comprising the computing system errors;
providing a respective timestamp associated with each of the tagged alerts;
generating a component name for each group of a plurality of groups, wherein each group correlates with a collection of the plurality of computing job operations;
calculating a delta time difference based on the timestamp between different computing job operations associated with each of the group;
identifying the component name for a target group of interest to a user from the plurality of groups, wherein the target group correlates with a target collection from among the collection of the plurality of computing job operations of interest to the user; and
identifying a name of a box job comprising a virtual machine associated with performing at least one from among the target group and a target computing job operation of interest to the user.

4. The method of claim 1, further comprising:
prompting, via the display interface, the user to make a selection of a particular node representing a particular computing job operation being of interest to the user;
receiving, from the user via the display interface, the selection; and
highlighting the particular node and the network of the nodes and the edges and the dependencies associated with the particular node in the context-aware knowledge graph model for viewing by the user via the display interface.

5. The method of claim 1, further comprising predicting future computing system errors via the context-aware knowledge graph model and the flagging algorithm by parsing and iterating through subsequent computing job operations derived from the plurality of computing job operations to generate the predictions of the future computing system errors.

6. The method of claim 1, further comprising: implementing a classification machine learning (ML) model that classifies automated alerts.

7. The method of claim 1, wherein the generating the context-aware knowledge graph model further comprises a feedback loop enabling the user to provide inputs to the context-aware knowledge graph model via the display interface to update the dependencies with at least one from among new dependencies and correct the dependencies.

8. A computing apparatus for generating a context-aware knowledge graph model that derives a root cause of computing system errors in computing environments, comprising:
a processor;
a memory;
a display; and
a communication interface coupled to each of the processor, the memory, and the display, wherein the processor is configured to:
receive a plurality of computing job operations comprising the computing system errors from a plurality of databases related to the computing environments;
compile a data dependency list for dependencies between each of the plurality of computing job operations;
compile a data structure dictionary based on the data dependency list;
generate a data structure array based on the data structure dictionary with data keys representing the each of the plurality of computing job operations and data values representing the dependencies that correlate with the data keys;
generate the context-aware knowledge graph model by parsing and iterating through the data structure array to create nodes in the context-aware knowledge graph model and link the nodes via edges based on a key value pairing between the data keys and the data values that derives the root cause of the computing system errors via tracing and correlating of the dependencies; and
display, to a user via a display interface, the context-aware knowledge graph model with a network of the nodes and the edges showing the tracing and the correlating of the dependencies between the plurality of computing job operations to the root cause of the computing system errors.

9. The computing apparatus of claim 8, wherein the root cause of the computing system errors comprises a root computing job operation with a root computing system error from which the dependencies of the plurality of computing job operations derive from.

10. The computing apparatus of claim 8, wherein the processor is further configured to generate a flagging algorithm by:
tagging alerts associated with each of the nodes in the context-aware knowledge graph model based on a labeling of the each of the nodes as at least one from among the root cause of computing system errors and a duplicate of the plurality of computing job operations comprising the computing system errors;
providing a respective timestamp associated with each of the tagged alerts;
generating a component name for each group of a plurality of groups, wherein each group correlates with a collection of the plurality of computing job operations;
calculating a delta time difference based on the timestamp between different computing job operations associated with each of the group;
identifying the component name for a target group of interest to a user from the plurality of groups, wherein the target group correlates with a target collection from among the collection of the plurality of computing job operations of interest to the user; and
identifying a name of a box job comprising a virtual machine associated with performing at least one from among the target group and a target computing job operation of interest to the user.

11. The computing apparatus of claim 8, wherein the processor is further configured to:
select, by the user via the display interface, a particular node representing a particular computing job operation being of interest to the user; and
highlight the particular node and the network of the nodes and the edges and the dependencies associated with the particular node in the context-aware knowledge graph model for viewing by the user via the display interface.

12. The computing apparatus of claim 8, wherein the processor is further configured to: predict future computing system errors via the context-aware knowledge graph model and the flagging algorithm by parsing and iterating through subsequent computing job operations derived from the plurality of computing job operations to generate the predictions of the future computing system errors.

13. The computing apparatus of claim 8, wherein the processor is further configured to: implement a classification machine learning (ML) model that classifies automated alerts.

14. The computing apparatus of claim 8, wherein the generate the context-aware knowledge graph model further comprises a feedback loop enabling the user to provide inputs to the context-aware knowledge graph model via the display interface to update the dependencies with at least one from among new dependencies and correct the dependencies.

15. A non-transitory computer readable storage medium storing instructions for generating a context-aware knowledge graph model that derives a root cause of computing system errors in computing environments, the non-transitory computer readable storage medium comprising executable code which, when executed by a processor, causes the processor to:
receive a plurality of computing job operations comprising the computing system errors from a plurality of databases related to the computing environments;
compile a data dependency list for dependencies between each of the plurality of computing job operations;
compile a data structure dictionary based on the data dependency list;
generate a data structure array based on the data structure dictionary with data keys representing the each of the plurality of computing job operations and data values representing the dependencies that correlate with the data keys;
generate the context-aware knowledge graph model by parsing and iterating through the data structure array to create nodes in the context-aware knowledge graph model and link the nodes via edges based on a key value pairing between the data keys and the data values that derives the root cause of the computing system errors via tracing and correlating of the dependencies; and
display, to a user via a display interface, the context-aware knowledge graph model with a network of the nodes and the edges showing the tracing and the correlating of the dependencies between the plurality of computing job operations to the root cause of the computing system errors.

16. The non-transitory computer readable storage medium of claim 15, wherein the root cause of the computing system errors comprises a root computing job operation with a root computing system error from which the dependencies of the plurality of computing job operations derive from.

17. The non-transitory computer readable storage medium of claim 15, wherein the storage medium comprising the executable code which, when executed by the processor, causes the processor to further generate a flagging algorithm by:
tagging alerts associated with each of the nodes in the context-aware knowledge graph model based on a labeling of the each of the nodes as at least one from among the root cause of computing system errors and a duplicate of the plurality of computing job operations comprising the computing system errors;
providing a respective timestamp associated with each of the tagged alerts;
generating a component name for each group of a plurality of groups, wherein each group correlates with a collection of the plurality of computing job operations;
calculating a delta time difference based on the timestamp between different computing job operations associated with each of the group;
identifying the component name for a target group of interest to a user from the plurality of groups, wherein the target group correlates with a target collection from among the collection of the plurality of computing job operations of interest to the user; and
identifying a name of a box job comprising a virtual machine associated with performing at least one from among the target group and a target computing job operation of interest to the user.

18. The non-transitory computer readable storage medium of claim 15, wherein the storage medium comprising the executable code which, when executed by the processor, causes the processor to further:
select, by the user via the display interface, a particular node representing a particular computing job operation being of interest to the user; and
highlight the particular node and the network of the nodes and the edges and the dependencies associated with the particular node in the context-aware knowledge graph model for viewing by the user via the display interface.

19. The non-transitory computer readable storage medium of claim 15, wherein the storage medium comprising the executable code which, when executed by the processor, causes the processor to further:
predict future computing system errors via the context-aware knowledge graph model and the flagging algorithm by parsing and iterating through subsequent computing job operations derived from the plurality of computing job operations to generate the predictions of the future computing system errors.

20. The non-transitory computer readable storage medium of claim 15, wherein the storage medium comprising the executable code which, when executed by the processor, causes the processor to further implement a classification machine learning (ML) model that classifies automated alerts; and
wherein the generate the context-aware knowledge graph model further comprises a feedback loop enabling the user to provide inputs to the context-aware knowledge graph model via the display interface to update the dependencies with at least one from among new dependencies and correct the dependencies.
